(19) United States
(12) Patent Application Publication
(10) Pub. No.: US 2024/0330338 A1
(43) Pub. Date: Oct. 3, 2024

(54) APPARATUSES, METHODS, AND COMPUTER PROGRAM PRODUCTS FOR GENERATING AUTOMATED RESOLUTION ACTIONS USING INTENT PROVIDED BY A TRAINED MACHINE LEARNING MODEL

(71) Applicants: ATLASSIAN PTY LTD, Sydney (AU); ATLASSIAN (US) LLC, San Francisco, CA (US)

(72) Inventors: Michael Ruflin, Elizabeth Bay (AU); Christopher Mann, Sydney (AU); Omprakash Kuppan, Bangalore (IN); Zhou Sha, San Francisco, CA (US)

(21) Appl. No.: 18/620,191

(22) Filed: Mar. 28, 2024

Related U.S. Application Data
(60) Provisional application No. 63/493,553, filed on Mar. 31, 2023.

(51) Int. Cl. G06F 16/33; G06F 16/335

(52) U.S. Cl. CPC G06F 16/334; G06F 16/335

(57) ABSTRACT

Methods, apparatuses, or computer program products provide for generating automated resolution actions using intent provided by a trained machine learning model. A service message object via a communication channel of a plurality of communication channels. The service message object defines a feature dataset associated with a service request for an application framework. Additionally, a machine learning model trained for intent recognition is applied to the feature dataset to generate an intent support label for the service message object. The intent support label is then correlated to a resolution data object related to a service resolution for the service request. Based on whether the resolution data object satisfies defined resolution criteria for the intent support label, a resolution action for the service request is initiated.

### CROSS REFERENCE TO RELATED APPLICATIONS

This application claims the benefit of U.S. Provisional Patent Application No. 63/493,553, titled “APPARATUSES, METHODS, AND COMPUTER PROGRAM PRODUCTS FOR GENERATING AUTOMATED RESOLUTION ACTIONS USING INTENT PROVIDED BY A TRAINED MACHINE LEARNING MODEL,” and filed on Mar. 31, 2023, the entirety of which is hereby incorporated by reference.

### BACKGROUND

It is often difficult to manage and/or support components of a server system in which inputs and/or components of the server system dynamically change. Through applied effort, ingenuity, and innovation, these identified deficiencies and problems have been solved by developing solutions that are configured in accordance with the embodiments of the present disclosure, many examples of which are described in detail herein.

### BRIEF SUMMARY

In an embodiment, an apparatus comprises one or more processors and one or more storage devices storing instructions that are operable, when executed by the one or more processors, to cause the one or more processors to receive a service message object via a communication channel of a plurality of communication channels. In one or more embodiments, the service message object defines a feature dataset associated with a service request for an application framework. The instructions are also operable, when executed by the one or more processors, to cause the one or more processors to apply a machine learning model trained for intent recognition to the feature dataset to generate an intent support label for the service message object. The instructions are also operable, when executed by the one or more processors, to cause the one or more processors to correlate the intent support label to a resolution data object related to a service resolution for the service request. Based on whether the resolution data object satisfies defined resolution criteria for the intent support label, the instructions are also operable, when executed by the one or more processors, to cause the one or more processors to initiate a first resolution action for the service request based at least in part on first resolution information related to a searchable database system or a generative system, or initiate a second resolution action for the service request based at least in part on second resolution information related to an automated response message object.

In another embodiment, a computer-implemented method provides for receiving a service message object via a communication channel of a plurality of communication channels. In one or more embodiments, the service message object defines a feature dataset associated with a service request for an application framework. The computer-implemented method also provides for applying a machine learning model trained for intent recognition to the feature dataset to generate an intent support label for the service message object. The computer-implemented method provides for correlating the intent support label to a resolution data object related to a service resolution for the service request. Based on whether the resolution data object satisfies defined resolution criteria for the intent support label, the computer-implemented method also provides for initiating a first resolution action for the service request based at least in part on first resolution information related to a searchable database system or a generative system, or initiating a second resolution action for the service request based at least in part on second resolution information related to an automated response message object.

In yet another embodiment, a computer program product is provided. The computer program product is stored on a computer readable medium, comprising instructions that when executed by one or more computers cause the one or more computers to receive a service message object via a communication channel of a plurality of communication channels. In one or more embodiments, the service message object defines a feature dataset associated with a service request for an application framework. The instructions, when executed by the one or more computers, also cause the one or more computers to apply a machine learning model trained for intent recognition to the feature dataset to generate an intent support label for the service message object. The instructions, when executed by the one or more computers, also cause the one or more computers to correlate the intent support label to a resolution data object related to a service resolution for the service request. Based on whether the resolution data object satisfies defined resolution criteria for the intent support label, the instructions, when executed by the one or more computers, also cause the one or more computers to initiate a first resolution action for the service request based at least in part on first resolution information related to a searchable database system or a generative system, or initiate a second resolution action for the service request based at least in part on second resolution information related to an automated response message object.

Various other embodiments are also described in the following detailed description and in the attached claims.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example system within which one or more embodiments of the present disclosure may operate;

FIG. 2 is a block diagram of an intent recognition apparatus configured in accordance with one or more embodiments of the present disclosure;

FIG. 3 illustrates an example system related to intent engine circuitry in accordance with one or more embodiments of the present disclosure;

FIG. 4 illustrates an example system related to resolution engine circuitry in accordance with one or more embodiments of the present disclosure;

FIG. 5 illustrates an example system related to a virtual agent system in accordance with one or more embodiments of the present disclosure;

FIG. 6 illustrates an example system related to an information retrieval system, a knowledge base system, and a machine reading comprehension model in accordance with one or more embodiments of the present disclosure;

FIG. 7 illustrates an example communication flow between an information retrieval system, a knowledge base system, and/or a machine reading comprehension model in accordance with one or more embodiments of the present disclosure;

FIG. 8 illustrates an example flow diagram related to intent engine circuitry and/or resolution engine circuitry in accordance with one or more embodiments of the present disclosure;

FIG. 9 is a flowchart diagram for an example process for processing multi-channel service data objects to initiate automated resolution action via an intent engine in accordance with one or more embodiments of the present disclosure; and

FIG. 10 is a flowchart diagram for an example process for generating automated resolution actions using intent provided by a trained machine learning model in accordance with one or more embodiments of the present disclosure.

### DETAILED DESCRIPTION OF VARIOUS EMBODIMENTS

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Various embodiments of the present disclosure address technical problems associated with efficiently and reliably managing server systems such as, for example, managing data objects, components, and/or communications provided to a server system. The disclosed techniques can be provided by an apparatus integrated with an application framework system where multiple components/resources and/or layers of components/resources interact with one another in several complex manners to provide collaborative applications and/or collaborative services.

An application framework (e.g., a cloud application framework) is typically characterized by a large number of the application components (e.g., services, micro services, and the like) that are offered by the application framework. One example application framework might include an enterprise instance of Jira®, an action tracking and project management software platform, developed by Atlassian Pty. Ltd. that may be licensed to Beta Corporation. Other software platforms may serve as application frameworks (e.g., Confluence®, Trello®, Bamboo®, Clover®, Crucible®, etc. by Atlassian Pty. Ltd) as will be apparent to one of ordinary skill in the art in view of the foregoing discussion.

Modern application frameworks are designed to possess complex service architectures and are deployed at scale to large enterprise user bases. Because of this scale and the numerosity of the application components, a large number of data objects may be generated by the application framework at most any time interval. These created data objects may be generated for a variety of purposes and can be difficult to track due to the sheer volume data objects and due to the complexity of the application framework. For example, the application framework may be configured as a collaborative service management framework and data objects may be generated as a result of service requests, information technology service tickets, information technology service messages, information technology workflow processes and/or other information technology support data provided to the collaborative service management framework.

Data objects generated and/or processed by an application framework may relate to the application framework itself such as, for example, data objects indicating service tickets, service messages, workflow action, software events, incidents, changes, component requests, alerts, notifications, and/or other data. However, data objects generated and/or processed by an application framework may also relate to information technology service management software that a business or enterprise has deployed or licensed in association with the application framework for managing service tickets, service messages, workflow actions, software events, incidents, changes, component requests, alerts, notifications, and/or other data, and the like. Example information technology service management software includes Jira Service Management™ and/or Opsgenie™ by Atlassian Pty. Ltd. Notably, data objects may be transmitted via multiple types of communication channels such as, for example, email, application portals, widgets, chat channels, application programming interface (API) calls, etc.

As an example, a data object may be related to a service ticket (e.g., a service management ticket) for a service request by a user (e.g., a help seeker user). Such a data object related to a service ticket may trigger routing to one or more system resources and/or application components of the application framework to provide a resolution for the service ticket. However, each processing path of the application framework to provide a possible resolution may result in inefficient usage of computing resources for the application framework. Moreover, given the complexity and scale of modern application frameworks, it can be difficult to manage and optimize data requirements and/or computing resources related to application components of such application frameworks. Accordingly, providing a resolution for a service ticket is often computationally expensive and/or may unduly strain computing resources of the application framework.

It is generally also difficult to obtain meaningful information related to service tickets, service messages, workflow actions, software events, incidents, changes, component requests, alerts, notifications, and/or other data provided to such application frameworks. For example, consider a scenario in which it is desirable for Beta Corporation to manage dynamic or static portions of a services management process such as, for example, an information technology service management process (or another type of application component process) such that service tickets and/or one or more service ticket workflow actions are automatically processed and resolved. However, traditional services management processes and/or workflows often result in a vast collection of unprocessed data, difficult traceability of data, inefficient usage of computing resources, and/or other technical drawbacks.

To address the above-described challenges related to managing server systems, various embodiments of the present disclosure are directed to systems, apparatuses, methods and/or computer program products for processing multi-channel service data objects to initiate automated resolution actions via an intent engine. The intent engine can be an intent classification model or another type of intent classifier that is configured and/or trained to recognize support intentions related to communications such as, for example, service tickets, service messages, email messages, application portal communications, widget communications, chat channels, web communications, API calls, alerts, notifications, telephone calls, video chats, and/or other communication data associated with an application framework. The intent engine can also be configured as a virtual agent engine for the application framework to automate support interactions with respect to the application framework via various communication channels. In various embodiments, the intent engine can include and/or can be integrated with a natural language processing engine, a machine learning model, a rules engine, a dialog engine, and/or one or more other system to process various communication channels and/or data provided therefrom.

The intent engine can be configured or trained to interpret intent, context, and/or sentiment related to the support interactions with respect to the application framework. For example, the intent engine can be configured or trained to perform intent extraction and/or related understanding capabilities across various communication channels. The intent extraction and/or related understanding can be based on interactions of a user with respect to a user device associated with a communication channel. The intent extraction and/or related understanding can additionally or alternatively be based on content of data provided via a communication channel. The intent engine can then convert the intent extraction and/or related understanding into an intent classification that can be correlated to a particular resolution data object for resolution of the service request. For example, the resolution data object can be related to automated service fulfillment, cross-channel service actions, knowledge database extraction, etc. Additionally or alternatively, the resolution data object can be related to automated responses, automated notifications, generation of knowledge database metadata, insights, etc.

In various embodiments, the intent engine can receive respective services messages via multiple communication channels. The intent engine can also generate respective support labels for the respective services messages based on a feature dataset associated with the respective services messages. The respective support labels can then be correlated to respective resolution data objects to initiate one or more automated resolution actions for the respective services messages.

In various embodiments, the application framework integrated with the intent engine can include components (e.g., application components, application micro-components, services, microservices, etc.) and a service event stream associated with the components can be monitored to trigger execution of the intent engine. Components of the application framework may include, for example, components related to one or more layers of the application framework. In one or more embodiments, the application framework may facilitate remote collaboration between components. In one or more embodiments, the intent engine employs a database associated with service event streams to track different service requests. In one or more embodiments, the intent engine interacts with components, applications, and/or tools of the application framework to synch data into the database. In one or more embodiments, the intent engine is integrated with an event management platform to enable collection of data objects for various service event streams. In certain embodiments, predetermined service actions can be automatically detected based on monitoring of one or more event streams associated with an application framework. In some embodiments, an API can be provided to interact with the intent engine. For instance, in some embodiments, an API-driven user interface can be provided to enable interaction with the intent engine. In one or more embodiments, the user interface provides a visualization related services requests managed by the intent engine.

By employing the intent engine to manage workflows related to an application framework, computing resources and/or memory allocation with respect to processing and storage of data for the application framework can be improved. In doing so, various embodiments of the present disclosure make substantial technical contributions to improving the efficiency and/or the effectiveness of an application framework system. Various embodiments of the present disclosure additionally or alternatively provide improved service request support, improved usability, improved data quality, improved interactions, improved processes, improved workflows, improved remote collaborations with respect to service event workflows related to an application framework. Moreover, various embodiments of the present disclosure additionally or alternatively provide improved model performance and/or scaling of a data labeling process for improved training of a model related to an intent engine.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

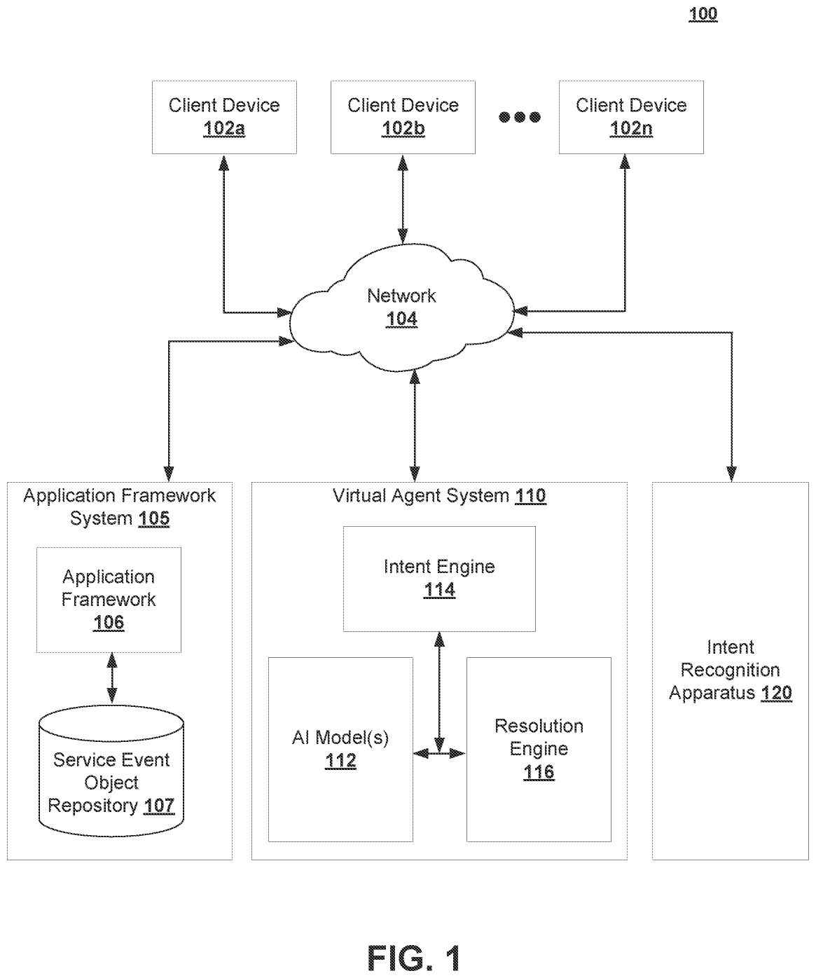

The term “server computing device” refers to a combination of computer hardware and/or software that is configured to provide a component to a client device. An example of a server computing device is the application framework system 105 of FIG. 1. Another example of a server computing device is, in certain embodiments, the virtual agent system 110 of FIG. 1. Another example of a server computing device is, in certain embodiments, the intent recognition apparatus 120 of FIG. 1. In some embodiments, a server computing device communicates with one or more client computing devices using one or more computer networks.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The term “application framework” refers to a computing environment associated with one or more computing devices and one or more components (e.g., one or more application components), where the environment enables interactions with respect to components supporting at least one application. For example, an application framework can be a system (e.g., a server system, a cloud-based system, an enterprise system, etc.) where multiple components, multiple resources associated with components, multiple layers of components, and/or multiple layers of resources interact with one another in several complex manners. In some embodiments, the components are associated directly or indirectly with an application supported by the components. In some embodiments, the components can support the application over one or more communication networks. The application framework can include one or more components to generate and update a repository of collected information for each component (e.g., an event object repository). Accordingly, the application framework can provide for the collection of information, in the form of service event objects, to facilitate monitoring of service event streams associated with one or more components of the application framework. In certain embodiments, the application framework can be configured as a service management software platform. In certain embodiments, the application framework can alternatively be configured to manage one or more project management applications, one or more work management applications, one or more software development applications, one or more product development applications, one or more portfolio management applications, one or more collaborative applications, or one or more other types of applications. In certain embodiments, the application framework can be configured as an enterprise instance of an information technology service management software platform. However, it is to be appreciated that, in other embodiments, the application framework can be configured as another type of component platform.

The term “application framework system” refers to a system that includes both a server framework and a repository to support the server framework. For example, an application framework refers to a system that includes a computing environment associated with one or more computing devices and one or more components, as well as a repository of collected information for each component and/or each computing device.

The term “application,” “app,” or similar terms refer to a computer program or group of computer programs designed for use by and interaction with one or more networked or remote computing devices. In some embodiments, an application refers to a mobile application, a desktop application, a command line interface (CLI) tool, or another type of application. Examples of an application comprise workflow engines, component desk incident management, team collaboration suites, cloud components, word processors, spreadsheets, accounting applications, web browsers, email clients, media players, file viewers, videogames, and photo/video editors. An application can be supported by one or more components either via direct communication with the component or indirectly by relying on a component that is in turn supported by one or more other components.

The term “component” or “component application” refers to a computer functionality or a set of computer functionalities, such as the retrieval of specified information or the execution of a set of operations, with a purpose that different clients can reuse for their respective purposes, together with the policies that should control its usage, for example, based on the identity of the client (e.g., an application, another component, etc.) requesting the component. Additionally, a component may support, or be supported by, at least one other component via a component dependency relationship. For example, a translation application stored on a smartphone may call a translation dictionary component at a server in order to translate a particular word or phrase between two languages. In such an example the translation application is dependent on the translation dictionary component to perform the translation task.

In some embodiments, a component is offered by one computing device over a network to one or more other computing devices. Additionally, the component may be stored, offered, and utilized by a single computing device to local applications stored thereon and in such embodiments a network would not be required. In some embodiments, components may be accessed by other components via a plurality of APIs, for example, JavaScript Object Notation (JSON), Extensible Markup Language (XML), Simple Object Access Protocol (SOAP), Hypertext Markup Language (HTML), the like, or combinations thereof. In some embodiments, components may be configured to capture or utilize database information and asynchronous communications via message queues (e.g., Event Bus). Non-limiting examples of components include an open source API definition format, an internal developer tool, web based HTTP components, databased components, and asynchronous message queues which facilitate component-to-component communications.

In some embodiments, a component can represent an operation with a specified outcome and can further be a self-contained computer program. In some embodiments, a component from the perspective of the client (e.g., another component, application, etc.) can be a black box (e.g., meaning that the client need not be aware of the component's inner workings). In some embodiments, a component may be associated with a type of feature, an executable code, two or more interconnected components, and/or another type of component associated with an application framework.

In some embodiments, a component may correspond to a service. Additionally or alternatively, in some embodiments, a component may correspond to a library (e.g., a library of components, a library of services, etc.). Additionally or alternatively, in some embodiments, a component may correspond to one or more modules. Additionally or alternatively, in some embodiments, a component may correspond to one or more machine learning models. For example, in some embodiments, a component may correspond to a service associated with a type of service, a service associated with a type of library, a service associated with a type of feature, a service associated with an executable code, two or more interconnected services, and/or another type of service associated with an application framework.

The term “service” refers to a type of component. In some embodiments, a service provides a visual representation of one or more data structures. In some embodiments, a service is configured for viewing data, searching for data, creating data, updating data, managing relationships among data, assigning attributes related to data, and/or storing data associated with one or more data structures. In some embodiments, a service is configured as a system, tool or product to facilitate viewing data, searching for data, creating data, updating data, managing relationships among data, assigning attributes related to data, and/or storing data associated with one or more data structures. In some embodiments, a service comprises a set of metadata attributes associated with a technical capability, a technical configuration, an application capability, an application configuration, and/or another metadata attribute. In some embodiments, a service is published to one or more client devices via one or more APIs. In some embodiments, a service is a logical representation of an application stack. In some embodiments, a service corresponds to one or more microservices.

The term “microservices” refers to a set of services that are interconnected and independently configured to provide a monolith service. In some embodiments, a microservice is configured with one or more APIs integrated with one or more other microservices and/or one or more other applications. In some embodiments, a microservice is a single-function module with a defined set of interfaces and/or a defined set of operations configured to integrate with one or more other microservices and/or one or more other applications to provide a monolith service.

The term “library” refers to a collection of objects (e.g., a collection of component objects, a collection of service objects, etc.), a collection of functions, and/or a collection of processing threads associated with one or more components.

The term “workflow” refers to a set of actions that represent one or more processes related to an application framework and/or one or more components. A workflow can include a set of statuses and/or a set of transitions that represent one or more processes. For example, a status can represent a state of an action and/or a task performed with respect to an application framework and/or one or more components. A transition can represent a link between status. Actions for a workflow can be configured to dynamically alter a current status of a workflow and/or to initiate a transition.

The term “service workflow event” refers to one or more actions, interactions with, and/or one or more changes related to a service workflow of an application framework and/or one or more components. In one or more embodiments, a service workflow event refers to one or more actions, interactions with, and/or one or more changes related to one or more service management applications, one or more project management applications, one or more work management applications, one or more software development applications, one or more product development applications, one or more portfolio management applications, one or more collaborative applications, or one or more other types of applications. In some embodiments, a service workflow event may be associated with metadata, a unique identifier, one or more attributes, one or more features, one or more tags, one or more source identifiers, one or more object types, and/or other context data. In some embodiments, a service workflow event may be related to and/or triggered via one or more client devices that interact with one or more components. For example, in some embodiments, a service workflow event can be related to one or more service requests initiated via a display screen of a client device. Additionally or alternatively, in some embodiments, a service workflow event may be triggered via one or more components and/or one or more user identifiers. In some embodiments, a service workflow event may be associated with a service workflow event stream.

The term “service workflow event stream” refers to a collection of service workflow events related to one or more components and/or one or more user identifiers. For example, a service workflow event stream can include a first service workflow event associated with at least one component, a second service workflow event associated with the at least one component, a third service workflow event associated with the at least one component, etc. In certain embodiments, a service workflow event stream refers to a collection of service workflow events related to a service management application, a project management application, a work management application, a software development application, a product development application, a portfolio management application, a collaborative application, or another type of application. In certain embodiments, a service workflow event stream can include one or more service message objects related to one or more service workflow events.

The term “user identifier” refers to one or more items of data by which a particular user of the application framework may be uniquely identified. For example, a user identifier can correspond to a particular set of bits or a particular sequence of data that uniquely identifies a user. In various embodiments, a user identifier corresponds to a user that is authorized to view, edit and/or work simultaneously on one or more workflows related to a project management application, a work management application, a service management application, a software development application, a product development application, a portfolio management application, a collaborative application, or another type of application.

The terms “internal component,” “internal resource,” or similar terms refer to a program, application, platform, or component that is configured by a developer to provide functionality to another one or more of their programs, applications, platforms, or components, cither directly or indirectly through one or more other components, as opposed to using an external component. Internal components operate on a compiled code base or repository that is at least partially shared by an application which utilizes the functionality provided by the internal component. In some embodiments, the application code base and the internal component code base are hosted on the same computing device or across an intranet of computing devices. An application communicates with internal components within a shared architectural programming layer without external network or firewall separation. In some embodiments, an internal component is used only within the application layer which utilizes the internal components functionality. Information related to internal components can be collected and compiled into component objects which can also be referred to as internal component objects. An example embodiment of an internal component is a load balancer configured for routing and mapping API and/or component locations. Internal components may be configured for information-based shard routing, or in other words, routing and mapping API and/or component locations based on predefined custom component requirements associated with an application. For example, an internal component may be configured to identify where communication traffic originates from and then reply to the communications utilizing another component for reply communication.

The terms “external component,” “external resource,” “remote resource,” or similar terms refer to a program, application, platform, or component that is configured to communicate with another program, application, platform, or component via a network architecture. In some embodiments, communications between an external component and an application calling the external component takes place through a firewall and/or other network security features. The external component operates on a compiled code base or repository that is separate and distinct from that which supports the application calling the external component. The external components of some embodiments generate data or otherwise provide usable functionality to an application calling the external component. In other embodiments, the application calling the external component passes data to the external component. In some embodiments, the external component may communicate with an application calling the external component, and vice versa, through one or more application program interfaces (APIs). For example, the application calling the external component may subscribe to an API of the external component that is configured to transmit data. In some embodiments, the external component receives tokens or other authentication credentials that are used to facilitate secure communication between the external component and an application calling the external component in view of the applications network security features or protocols (e.g., network firewall protocols). An example embodiment of an external component may include cloud components (e.g., AWS®).

The term “interface element” refers to a rendering of a visualization and/or human interpretation of data associated with an application framework. In one or more embodiments, an interface element may additionally or alternatively be formatted for transmission via one or more networks. In one or more embodiments, an interface element may include one or more graphical elements and/or one or more textual elements.

The term “visualization” refers to visual representation of data to facilitate human interpretation of the data. In some embodiments, visualization of data includes graphic representation and/or textual representation of data.

The term “repository” refers to a database, a datastore, and/or a memory device which is accessible by one or more computing devices for retrieval and storage of one or more data components, the like, or combinations thereof. The repository may be configured to organize data components stored therein in accordance with one or more particular data classification labels or other attributes attributed to the data component (e.g., a scoring metric, file size, file type, etc.). For example, a repository may be structured in accordance with one or more data components associated with one or more services, applications, data classification labels, internal resources, external resources, network functions, APIs, the like, or combinations thereof. In some embodiments, a repository may be at least partially stored on one or more of a server, remotely accessible by a computing device, or on a memory device on-board the computing device. In some embodiments, a repository is configured as a service event object repository associated with the one or more events.

The term “communication channel” refers to a wired or wireless transmission medium for transmitting data between a client device and an application framework system. To communicatively couple a client device and an application framework system, a communication channel can be integrated with a component management interface, an API, a communication interface. In an example, the communication channel can be a network communication channel that communicatively couples a client device and an application framework. A communication channel can be related to a portal, chat, email, web, widget, API call, text, notification, telephone, video, and/or other type of communication. In various embodiments, a communication channel can be configured for transmitting messages and/or signals such as, for example, service messages or service signals, between a client device and an application framework.

The term “service message object” refers to a data structure that represents at least a portion of a service message related to a service request for the application framework system. The service message object can take the structural form of a vector or other appropriate data structure for representing a service message. Additionally, a service message object can be received by one or more computing devices (e.g., servers, systems, platforms, etc.) which are configured to cause an application framework system to perform one or more actions associated with one or more service event workflows and/or one or more components of the application framework system.

The service message object may be received by an application framework system via a communication channel or the like. In one or more embodiments, the service message object may be generated by a client device via one or more computer program instructions. In various embodiments, a service message object can be generated via a service ticket, a service message, a service request, a service conversation, an API call, an application portal, a chat message conversation, an email exchange, a web interface, a widget interface, a workflow, a collaborative dashboard, a service management application, a project management application, a work management application, a software development application, a product development application, a portfolio management application, a collaborative application, or another type of process related to an application framework. Additionally or alternatively, a service message object may be cause one or more actions, one or more changes, and/or one or more authorizations with respect to a service ticket, a service message, a service request, a service conversation, an API call, an application portal, a chat message conversation, an email exchange, a web interface, a widget interface, a workflow, a collaborative dashboard, a service management application, a project management application, a work management application, a software development application, a product development application, a portfolio management application, a collaborative application, or another type of process related to an application framework.

The term “response message object” refers a data structure that represents at least a portion of a response message generated in response to a service request for the application framework system. The response message object can take the structural form of a vector or other appropriate data structure for representing a response message. Additionally, a response message object can be received by one or more client devices which provided a related service message object. In various embodiments, a response message object is generated by a virtual agent system to obtain additional information related to a related service message object.

The term “feature dataset” refers to one or more features, data items or data elements associated with a service message object that are collected and represented as part of a feature dataset. The feature dataset may refer to any information associated with a service message object and/or a client device associated with a service message object, such as, for example, unstructured service message data, metadata, a source identifier, a user identifier, one or more object types, feature extraction data, one or more text features, one or more numeric features, binary encoding data, text vectorization data, segmentation data, one or more NLP features, word encodings, term frequency-inverse document frequency (TF-IDF) data, N-gram data, named entity recognition (NER) data, one or more audio features, context data, associated computing devices, IP addresses, location information for a client device (e.g., GPS information), access logs, the like, or combinations thereof.

The term “expected communication parameter set” refers to one or more parameters, data items or data elements associated with a communication channel. The expected communication parameter set may refer to any information associated with a communication channel such as, for example, a channel type, temporality information, fidelity information, structuredness information, scope information the like, or combinations thereof associated with a communication channel.

The term “support label” refers to a data label for a service message object as provided by an intent engine configured for supervised learning, unsupervised learning, or reinforcement learning of intent associated with a service request. A support label can be a classification, a target class, a prediction, an inference, a tag, a sentiment, a word embedding, a data vector, or another type of label associated with intent recognition with respect to a service message object.

The term “intent engine” refers to a model such as, for example, a classifier model, an NLP model, a machine learning model, or another type of model that is configured to recognize intent associated with service message objects. An intent engine can be trained based on training data comprising one or more feature datasets.

The term “resolution data object” refers to a data structure that represents one or more resolution actions for a service message object. A resolution data object can include and/or be configured as a message, an alert, a notification, a control signal, an API call, an email message, an application portal communication, a widget communication, a chat channel communication, a web communication, API calls, a set of executable instructions, a workflow, a resolution ticket, visual data, the like, or combinations thereof. In certain embodiments, a resolution action can be performed with respect to an application framework system. For example, a resolution action can be associated with one or more workflow events with respect to one or more components of an application framework. In certain embodiments, a resolution action can be associated with one or more workflow events with respect to one or more service management applications, one or more project management applications, one or more work management applications, one or more software development applications, one or more product development applications, one or more portfolio management applications, one or more collaborative applications, or one or more other types of applications managed by an application framework. In certain embodiments, a resolution action can be performed with respect to a client device, a support device, or another type of computing device. In certain embodiments, a resolution action can be performed with respect to a user interface of a client device, a support device, or another type of computing device to render visual data associated with a respective resolution data object.

The term “searchable database system” refers to a system that capable of being searched and/or queried to provide resolution information for a service message object. In certain embodiments, a searchable database system includes and/or corresponds to a knowledge base system. In certain embodiments, a searchable database system additionally or alternatively includes and/or corresponds to a machine reading comprehension model.

The term “machine learning model” refers to a data entity that describes parameters, hyper-parameters, and/or defined operations configured, trained, and/or the like to generate an output for a predictive task, a classification task, and/or a generative task using machine learning techniques. For example, a machine learning model can include one or more layers, one or more rule-based layers, one or more neural network layers, and/or one or more other types of layers that depend on trained parameters, coefficients, and/or the like. In some embodiments, machine learning model can include any type of model configured, trained, and/or the like to generate an output for a predictive task, a classification task, and/or a generative task in any predictive domain. A machine learning model can include one or more of any type of machine learning model including one or more supervised, unsupervised, semi-supervised, reinforcement learning models, and/or the like. For instance, a machine learning model may include a supervised model that can be trained using a historical training dataset. In some examples, a machine learning model can include multiple models configured to perform one or more different stages of a classification and/or prediction process. In various embodiments, a machine learning model can be configured as a neural network model, a deep learning model, a convolutional neural network (CNN) model, a natural language processing (NLP) model, a large language model (LLM), a generative model, and/or another type of machine learning model.

In some embodiments, a machine learning model is designed and/or trained for a particular predictive domain associated with an application framework. In various embodiments, a machine learning model is designed and/or trained to apply one or more machine learning techniques to a feature dataset associated with a service message object. In some embodiments, a machine learning model, for example, can be trained, using a historical training dataset, to generate a classification and/or prediction for intent recognition based the feature dataset.

In some embodiments, a machine learning model is designed and/or trained for one or more generative resolution tasks associated with an application framework. In some embodiments, a machine learning model can be a generative machine learning model designed and/or trained for generating resolution information for a service message object. For example, a machine learning model can be a generative machine learning model configured for generating data that represents at least a portion of a resolution action for a service message object.

The term “generative machine learning model” refers to a data entity that describes parameters, hyper-parameters and/or defined operations configured, trained, and/or the like to generate an output for a particular generative task using machine learning techniques. In some embodiments, the generative machine learning model is configured to generate output such as text, one or more images, audio, video, one or more interface elements, and/or other content for a response message object. In some embodiments, a generative machine learning model is configured as a LLM, a generative pre-trained transformer (GPT) model, or another type of generative machine learning model configured to generate an output for a particular generative task.

The term “generative system” refers to a system that capable of generating resolution information for a service message object. In certain embodiments, a generative system includes and/or corresponds to one or more generative machine learning models. In certain embodiments, a generative system additionally or alternatively includes and/or corresponds to one or more other systems and/or models configured to generate resolution information for a service message object.

The term “machine reading comprehension model” refers to a data entity that describes parameters, hyper-parameters and/or defined operations configured, trained, and/or the like to interpret text and/or generate resolution information for a resolution data object. In some embodiments, a machine reading comprehension model is a machine learning model that includes parameters, hyper-parameters and/or defined operations configured, trained, and/or the like to interpret text and/or generate resolution information for a resolution data object using machine learning techniques. In some embodiments, a machine reading comprehension model utilizes NLP to interpret text and/or generate resolution information for a resolution data object. In some embodiments, a machine reading comprehension model is configured as a Bidirectional Encoder Representations from Transformers (BERT) language model associated with a transformer architecture that includes a plurality of encoders.

Thus, use of any such terms, as defined herein, should not be taken to limit the spirit and scope of embodiments of the present disclosure.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, virtual reality device, augmented reality device, the like, or any combination of the aforementioned devices.

FIG. 1 illustrates an example system architecture 100 within which embodiments of the present disclosure may operate. The system architecture 100 includes an application framework system 105 configured to interact with one or more client devices 102a-n, such as client device 102a, client device 102b, and/or client device 102n. In one or more embodiments, the one or more client devices 102a-n may be configured to interact with one or more components managed by an application framework 106 of the application framework system 105. For example, in one or more embodiments, the one or more client devices 102a-n may be configured to send data to the one or more components managed by the application framework 106 and/or receive data from the one or more components managed by the application framework 106. In one or more embodiments, the one or more components can be related to one or more service messages, one or more service requests, one or more service tickets, one or more service conversations, one or more notifications, one or more workflows, a collaborative IT service management document, a collaborative IT service management dashboard, collaborative software management, and/or another type of application provided by the application framework 106.

The system architecture 100 also includes a virtual agent system 110 and/or an intent recognition apparatus 120. In an embodiment, the intent recognition apparatus 120 is implemented separate from the virtual agent system 110 and the application framework system 105. Alternatively, in certain embodiments, the virtual agent system 110 can include the intent recognition apparatus 120. For example, in certain embodiments, the intent recognition apparatus 120 can be integrated with the intent engine 114 and/or the resolution engine 116. Alternatively, in certain embodiments, the application framework system 105 can include the intent recognition apparatus 120. In various embodiments, the virtual agent system 110 and/or the intent recognition apparatus 120 can also be configured to interact with the one or more client devices 102a-n. In one or more embodiments, the virtual agent system 110 can include one or more AI models 112, an intent engine 114, and/or a resolution engine 116.

The application framework system 105, the virtual agent system 110, the intent recognition apparatus 120, and/or the one or more client devices 102a-n may be in communication using a network 104. Additionally or alternatively, in various embodiments, the application framework system 105, the virtual agent system 110, and/or the intent recognition apparatus 120 may be in communication via a backend network and/or an enterprise network separate from the one or more client devices 102a-n. The network 104 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers, etc.). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JSON objects sent via a WebSocket channel. In some embodiments, the protocol is JSON over RPC, JSON over REST/HTTP, the like, or combinations thereof.

A client device from the one or more client devices 102a-n may include a mobile device, a smart phone, a tablet computer, a laptop computer, a wearable device, a personal computer, an enterprise computer, a virtual reality device, an augmented reality device, or another type of computing device. In certain embodiments, at least one client device from the one or more client devices 102a-n can be a support device or another type of computing device configured for consuming resolution data objects and/or data associated therewith. In one or more embodiments, a client device from the one or more client devices 102a-n includes geolocation circuitry configured to report a current geolocation of the client device. In some embodiments, the geolocation circuitry of the client device may be configured to communicate with a satellite-based radio-navigation system such as the global position satellite (GPS), similar global navigation satellite systems (GNSS), or combinations thereof, via one or more transmitters, receivers, the like, or combinations thereof. In some embodiments, the geolocation circuitry of the client device may be configured to infer an indoor geolocation and/or a sub-structure geolocation of the client device using signal acquisition and tracking and navigation data decoding, where the signal acquisition and tracking and the navigation data decoding is performed using GPS signals and/or GPS-like signals (e.g., cellular signals, etc.). Other examples of geolocation determination include Wi-Fi triangulation and ultra-wideband radio technology.

In one or more embodiments, the application framework system 105 may be configured to receive one or more service message objects from one or more of the client devices 102a-n. A service message object can be configured to cause one or more actions with respect to the application framework 106, the intent recognition apparatus 120, and/or the virtual agent system 110. For example, a service message object can be configured to cause one or more actions with respect to one or more workflows managed by the application framework 106. Additionally or alternatively, a service message object can be configured to cause one or more actions with respect to intent recognition and/or one or more resolution actions as provided by the intent recognition apparatus 120, and/or the virtual agent system 110. A service message object may be generated by the one or more client devices 102a-n and may be received via a communication channel associated with the application framework 106, a component management interface of the application framework 106, an API of the application framework 106, a communication interface of the application framework 106, the like, or combinations thereof. The communication channel can be related to a portal, widget, chat, email, web, text, notification, telephone, video, and/or other type of communication. Based on the one or more service message objects, the application framework system 105 may perform one or more actions with respect to the application framework 106. Additionally or alternatively, based on the one or more service message objects, the intent recognition apparatus 120 and/or the virtual agent system 110 can perform one or more actions to determine one or more resolution actions for the one or more service message objects. In various embodiments, the one or more actions can be associated with one or more service workflow events with respect to one or more components of the application framework 106. For example, the one or more actions can initiate and/or correspond to one or more service workflow events with respect to one or more components of the application framework 106. In certain embodiments, the one or more actions can be associated with one or more service workflow events with respect to one or more service management applications, one or more project management applications, one or more work management applications, one or more software development applications, one or more product development applications, one or more portfolio management applications, one or more collaborative applications, or one or more other types of applications managed by the application framework 106.

In various embodiments, the application framework system 105 may include a service event object repository 107 associated with the one or more events. The service event object repository 107 may store event data for one or more one or more service message objects related to the one or more service request signals provided to the application framework 106. For example, the service event object repository 107 may store data associated with service message objects, service messages, service tickets, service workflow action, software events, incidents, changes, component requests, alerts, notifications, API calls, and/or other data. The service event object repository 107 may include one or more storage units, such as multiple distributed storage units that are connected through a computer network. Each storage unit in the service event object repository 107 may store at least one of one or more data assets and/or one or more data about the computed properties of one or more data assets. Moreover, each storage unit in the service event object repository 107 may include one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

In one or more embodiments, the data stored in the service event object repository 107 can be employed by the virtual agent system 110 and/or the intent recognition apparatus 120 to train the one or more AI models 112, to execute the one or more AI models 112, to execute the intent engine 114, and/or to execute the resolution engine 116.

In various embodiments, the intent engine 114 and/or the resolution engine 116 can employ the one or more AI models 112. For example, the intent engine 114 can employ the one or more AI models 112 to determine intent related to one or more service message objects provided to the application framework system 105. In an embodiment, the intent engine 114 can employ the one or more AI models 112 to determine intent (e.g., support intentions) related to service tickets and/or service messages provided to the application framework 106. Additionally, the resolution engine 116 can employ the one or more AI models 112 to determine a resolution related to the one or more service message objects. In an embodiment, the resolution engine 116 can employ the one or more AI models 112 to determine one or more resolution actions based on the intent (e.g., support intentions) related to service tickets and/or service messages.

In one or more embodiments, the one or more AI models 112 include a classification model, a machine learning model, a deep learning model, a neural network model, an NLP model, the like or a combination thereof associated with intent recognition. Additionally or alternatively, the one or more AI models 112 include a classification model, a machine learning model, a deep learning model, a neural network model, the like or a combination thereof associated with resolution actions. In various embodiments, the one or more AI models 112 can be trained based on one or more training datasets that comprises a support intent classification dataset, a support label dataset, and/or other training data. For example, during training, parameters (e.g., hyperparameters) and/or weights of the one or more AI models 112 can be tuned to learn a mapping function for intent recognition and/or resolution actions related to service message data (e.g., support requests). In certain embodiments, the one or more AI models 112 can be trained using a graphics processing unit (GPU). For example, in certain embodiments, a processor (e.g., processor 202) of the intent recognition apparatus 120 can be configured as a GPU to facilitate training of the one or more AI models 112. The one or more AI models 112 can be repeatedly trained until desired metrics, accuracy, and/or precision are achieved for intent recognition and/or resolution actions. In various embodiments, a training process and/or a training stage for the one or more AI models 112 can employ an F1 score, a mean reciprocal rank, a mean average precision, and/or another metrics indicator to determine whether desired metrics, accuracy, and/or precision are achieved.

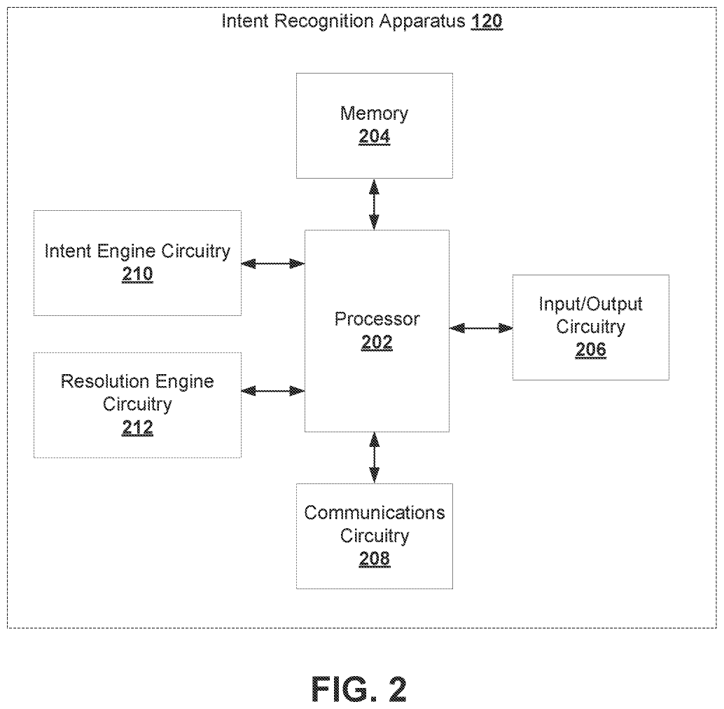

The intent recognition apparatus 120 may be embodied by one or more computing systems, such the intent recognition apparatus 120 illustrated in FIG. 2. In one or more embodiments, the intent recognition apparatus 120 may include processor 202, memory 204, input/output circuitry 206, communications circuitry 208, intent engine circuitry 210, and/or resolution engine circuitry 212. The intent recognition apparatus 120 may be configured to execute the operations described herein. Although these components 202-212 are described with respect to functional limitations, it should be understood that the particular implementations necessarily include the use of particular hardware. It should also be understood that certain of these components 202-212 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

In some embodiments, the intent recognition apparatus 120 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the intent recognition apparatus 120. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

The intent engine circuitry 210 may be any means such as a device or circuitry embodied in either hardware or a combination of hardware and software that is configured to interact with the intent engine 114 and/or facilitate intent recognition associated with the intent engine 114. In various embodiments, the intent engine circuitry 210 may be configured to additionally or alternatively interact with the one or more AI models 112. In various embodiments, the intent engine circuitry 210 may monitor, analyze, and/or process data associated with the application framework system 105 such as, for example, service message objects provided by client devices 102a-n and/or service data stored in the service event object repository 107. For example, in various embodiments, the intent engine circuitry 210 may monitor service event streams associated with the application framework 106 to detect respective service message objects related to client devices 102a-n and/or components of the application framework 106. In certain embodiments, the intent engine circuitry 210 may be configured to retrieve metadata associated with the application framework 106 and/or the service event object repository 107 to facilitate detection of respective service message objects related to client devices 102a-n and/or components of the application framework 106. The metadata may include, for example, data associated with relationships, sources, targets, ownership, consumption, libraries, activities, attributes, incidents, actions, service workflow events, communication channels, dashboards, data repositories, labels, descriptions, and/or other data related to the application framework 106, the service event object repository 107, and/or client devices 102a-n.

In some embodiments, to facilitate monitoring of service event streams, the intent engine circuitry 210 can be configured to ping one or more computing devices of the application framework 106, such as via an internet control message protocol, to receive information related to one or more components of the application framework 106. In some embodiments, to obtain service event objects associated with the one or more components, the intent engine circuitry 210 utilizes the communications circuitry 208 to transmit one or more API calls to one or more API servers associated with the noted client devices.

In some embodiments, the service event object repository 107 may comprise one or more of a single unified repository, a single partitioned repository, or a plurality of isolated repositories comprising one or more partitions. An example embodiment of service event object repository 107 may comprise separate partitions for isolating information for respective user identifiers associated with a defined portion of the service event object repository 107. The intent engine circuitry 210 may also be configured to generate access logs and/or historical data including information associated with a particular user identifier, computing device, component, the like, or combinations thereof. Historical data may include component activity records for a particular time interval.

The resolution engine circuitry 212 may be any means such as a device or circuitry embodied in either hardware or a combination of hardware and software that is configured to interact with the resolution engine 116 and/or facilitate resolution actions associated with the resolution engine 116. In various embodiments, the resolution engine circuitry 212 may be configured to additionally or alternatively interact with the one or more AI models 112. The resolution engine circuitry 212 may be configured to additionally or alternatively interact with client device 102a-n to facilitate resolution actions associated with the resolution engine 116.

In some embodiments, one or more external systems (such as a remote cloud computing and/or data storage system) may also be leveraged to provide at least some of the functionality discussed herein.

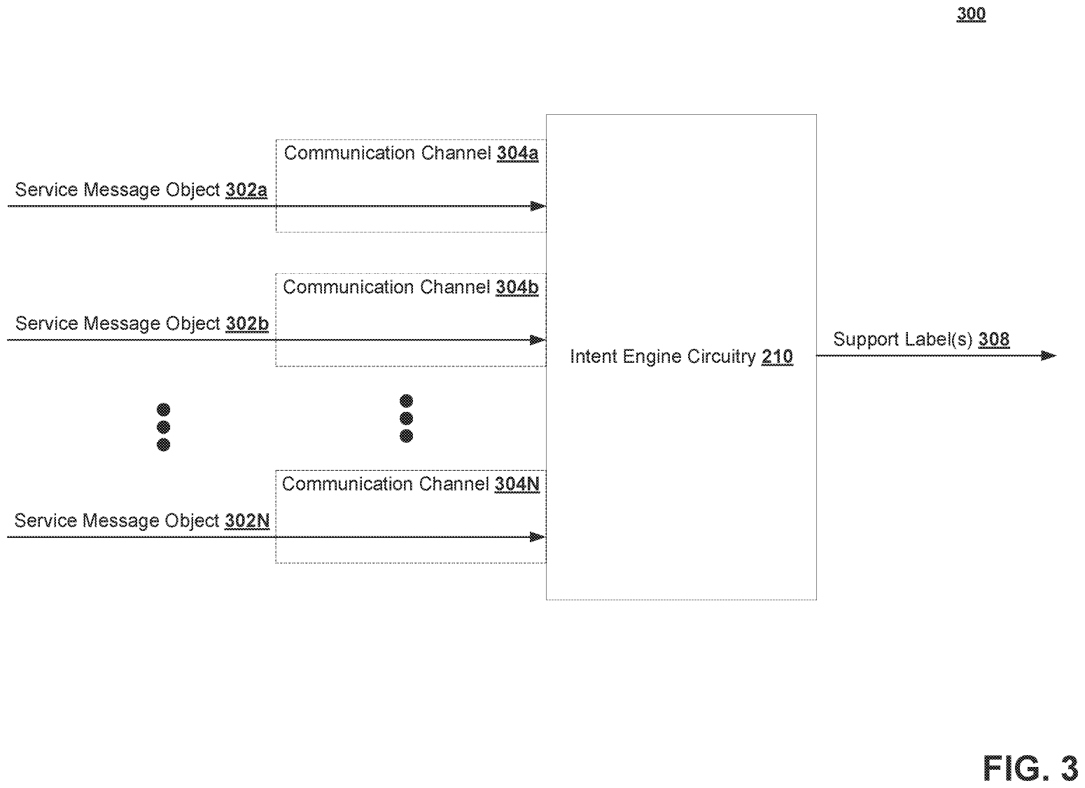

Referring now to FIG. 3, an example system 300 is presented in accordance with one or more embodiments of the present disclosure. The system 300 can be related to one or more processes performed by at least the intent recognition apparatus 120. The system 300 includes the intent engine circuitry 210 of the intent recognition apparatus 120. In one or more embodiments, the intent engine circuitry 210 receives one or more service message objects 302a-N. The one or more service message objects 302a-N can be respectively received via one or more communication channels 304a-N. For example, the intent engine circuitry 210 can receive a first service message object 302a via a first communication channel 304a, a second service message object 302b via a second communication channel 304b, etc. In various embodiments, the one or more communication channels 304a-N can be a plurality of communication channels respectively corresponding to an email communication channel, a network portal interface communication channel, a user interface widget communication channel, a chat communication channel, an API communication channel, or another type of communication channel.

The one or more service message objects 302a-N can respectively define a feature dataset associated with a respective communication channel. For example, the first service message object 302a can define a first feature dataset associated with the first communication channel 304a, the second service message object 302b can define a second feature dataset associated with the second communication channel 304b, etc. Additionally, the one or more communication channels 304a-N can respectively define an expected communication parameter set. For example, the first communication channel 304a can define a first expected communication parameter set, the second communication channel 304b can define a second expected communication parameter set, etc. In various embodiments, a respective feature dataset, communication channel, and/or expected communication parameter set related to a service message object from the one or more service message objects 302a-N can be different as compared to another service message object from the one or more service message objects 302a-N. For instance, the first feature dataset, the first communication channel 304a, and/or the first expected communication parameter set associated with the service message object 302a can each be respectively different from the second feature dataset, the second communication channel 304b, and/or the second expected communication parameter set associated with the service message object 302b.

In a non-limiting example, the service message object 302a can define a feature dataset associated with a chat communication channel (e.g., the communication channel 304a) where the chat communication channel defines an expected communication parameter set related to the chant communication channel and/or chat communications. Additionally, in the non-limiting example, the service message object 302b can define a different feature dataset associated with a network portal interface communication channel (e.g., the communication channel 304b) where the network portal interface communication channel defines a different expected communication parameter set related to the network portal interface communication channel and/or network portal interface communications.

In certain embodiments, the one or more service message objects 302a-N can include data stored in the service event object repository 107. For instance, the one or more service message objects 302a-N can include data related to service tickets and/or service messages provided to the application framework 106. In various embodiments, the one or more service message objects 302a-N can respectively include data related to a service conversation that contains a collection of service messages. The service messages can be one or more stored service messages and/or one or more ongoing service messages with respect to the application framework system 105.

In certain embodiments, the one or more service message objects 302a-N can be associated with a particular user identifier. For example, a service request signal can be received from a user identifier via a user interface of a client device associated with the user identifier. As such, in certain embodiments, the intent engine circuitry 210 can uniquely configure intent recognition based on the particular user identifier.

Based at least in part on the respective feature datasets for the one or more service message objects 302a-N, the intent engine circuitry 210 can generate a respective support label 308 for the one or more service message objects 302a-N. The support label 308 can be, for example, a data label, a classification, a target class, a prediction, an inference, a tag, a sentiment, a word embedding, a data vector, or another type of label associated a respective intent with respect to the one or more service message objects 302a-N.

In certain embodiments, the intent engine 114 can be configured to perform one or more clustering techniques with respect to the one or more service message objects 302a-N to generate the support labels 308. In certain embodiments, the support labels 308 can include a classification for respective support request types. For example, the support labels 308 can include a list of categories related to support requests, where the respective categories in the list of categories correspond to a potential issue and/or workflow to resolve the issue. In various embodiments, the intent engine 114 can group service message data (e.g., support requests) associated with the one or more service message objects 302a-N based on similarity (e.g., common intents) to generate respective groups of service message data. Additionally, the intent engine 114 can assign a support intent classification to the respective groups based on an inferred support intent for the respective groups. For example, the support intent classifications can correspond to respective support question classes (e.g., QuestionClass1, QuestionClass2, etc.) such that support questions in the same IT support question class can comprise a corresponding meaning. In certain embodiments, the intent engine 114 can employ a sentence encoder (e.g., a universal sentence encoder) to perform the one or more clustering techniques and/or to classify data in the one or more service message objects 302a-N. For example, the intent engine 114 can be configured to encode text included in the one or more service message object 302a-N into embedding vectors employed for text classification, semantic understanding, clustering, and/or natural language processing.

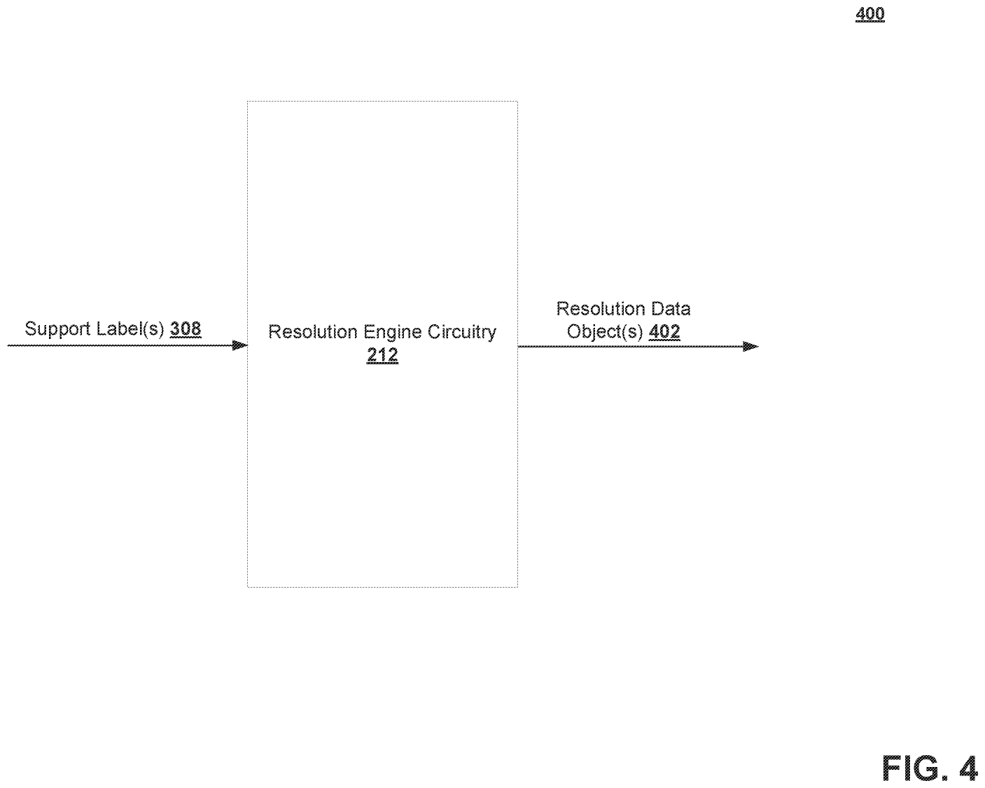

Referring now to FIG. 4, an example system 400 is presented in accordance with one or more embodiments of the present disclosure. The system 400 can be related to one or more processes performed by at least the intent recognition apparatus 120. The system 400 includes the resolution engine circuitry 212 of the intent recognition apparatus 120. In one or more embodiments, the resolution engine circuitry 212 receives the one or more support labels 308 related to the one or more service message objects 302a-N. The resolution engine circuitry 212 can correlate the one or more support labels 308 for the one or more service message objects 302a-N to respective resolution data objects 402. The one or more resolution data objects 402 can be respectively related to one or more resolution actions. In various embodiments, the resolution engine circuitry 212 can correlate the one or more support labels 308 to the respective resolution data objects 402 based at least in part on a respective expected communication parameter set for a related communication channel. For example, the resolution engine circuitry 212 can correlate the support labels 308 for the first service message object 302a and the second service message object 302b to respective resolution data objects 402 related to one or more resolution actions based at least in part, respectively, on the first expected communication parameter set for the communication channel 304a and on the second expected communication parameter set for the communication channel 304b.

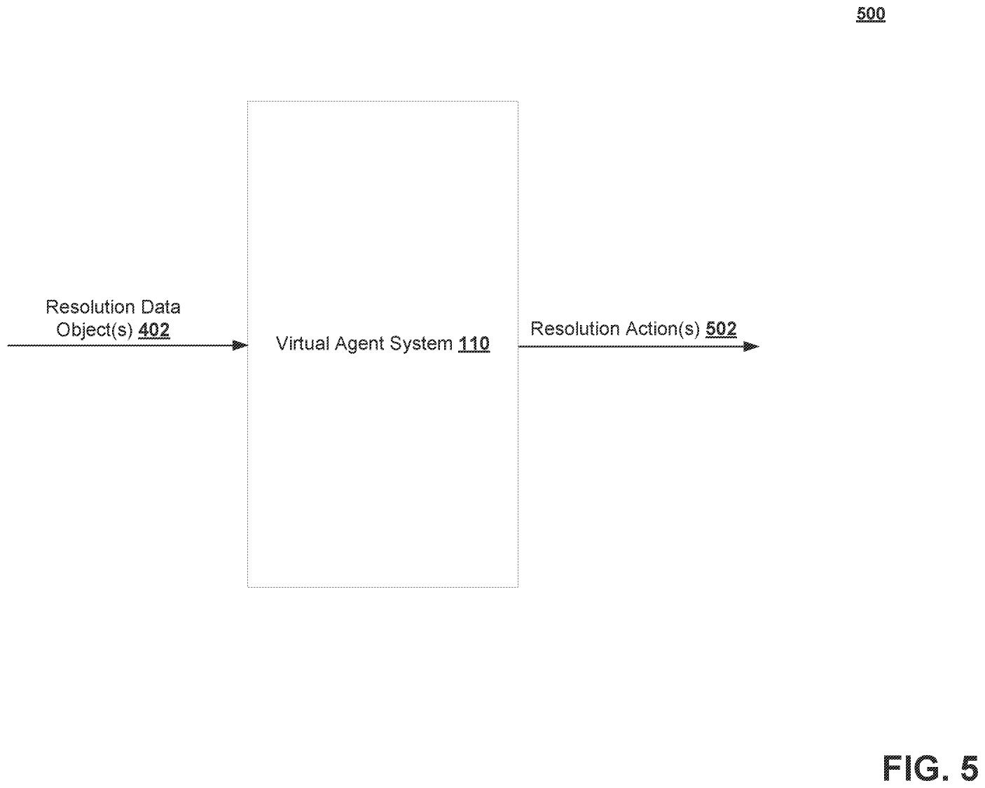

Referring now to FIG. 5, an example system 500 is presented in accordance with one or more embodiments of the present disclosure. The system 500 includes the virtual agent system 110 and the system 500 can be related to one or more processes performed by at least the virtual agent system 110. In one or more embodiments, the virtual agent system 110 receives the one or more resolution data objects 402 from the resolution engine 116 to initiate one or more resolution actions 502. In certain embodiments, the resolution engine 116 of the virtual agent system 110 can initiate the one or more resolution actions 502 based on the one or more resolution data objects 402. The one or more resolution actions 502 can be one or more automated actions with respect to the application framework 106 and/or the one or more clients 102a-n. In certain embodiments, the one or more resolution actions 502 can include generation and/or transmission of a message, an alert, a notification, a control signal, an API call, an email message, an application portal communication, a widget communication, a chat channel communication, a web communication, API calls, a set of executable instructions, a workflow, a resolution ticket, visual data, the like, or combinations thereof associated with the one or more resolution data objects 402. Additionally or alternatively, the one or more resolution actions 502 can be associated with one or more workflow events with respect to one or more components of the application framework 106. In one embodiment, the one or more resolution actions 502 can include generating a resolution message object for a client device from the one or more client devices 102a-n based at least in part on the respective resolution data objects 402. The resolution message object can be configured, for example, to render visual data associated with the respective resolution data objects 402 via a user interface of the client device. In another embodiment, the one or more resolution actions 502 can include routing a resolution ticket data object to a support device based at least in part on the respective resolution data objects 402.

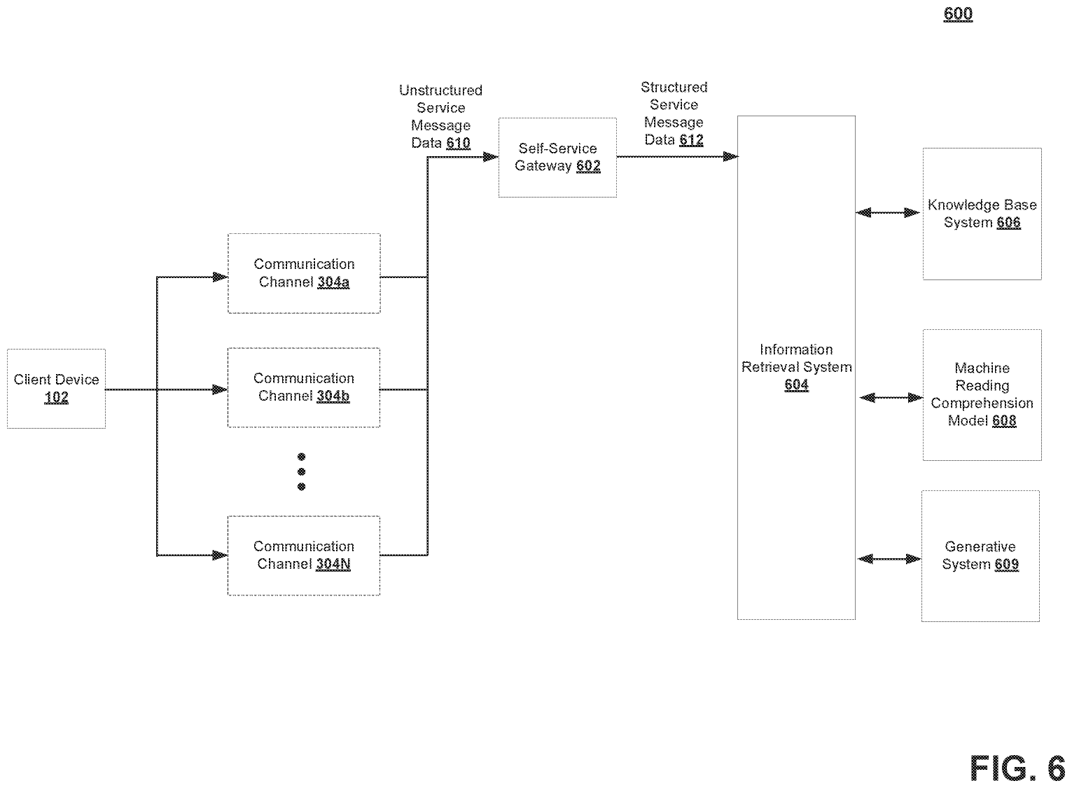

Referring now to FIG. 6, an example system 600 is presented in accordance with one or more embodiments of the present disclosure. The system 600 includes a self-service gateway 602, an information retrieval system 604, a knowledge base system 606, a machine reading comprehension model 608, and/or a generative system 609 that can process unstructured service message data 610 received via a communication channel of the one or more communication channels 304a-N. For example, a client device 102 of the one or more client device 102a-n can transmit the unstructured service message data 610 via a communication channel of the one or more communication channels 304a-N. The self-service gateway 602 can be a gateway device for the application framework system 105, the intent recognition apparatus 120, and/or the virtual agent system 110. For example, the self-service gateway 602 can be configured to transform the unstructured service message data 610 into structured service message data 612 capable of being further processed by the information retrieval system 604. The unstructured service message data 610 can be, for example, unstructured data related to a message, an alert, a notification, an API call, an email message, an application portal communication, a widget communication, a chat channel communication, a web communication, or the like provided by the client device 102. The structured service message data 612 can be, for example, a question, a phrase, or other structured data related to a service request. The structured service message data 612 can be extracted from the unstructured service message data 610 and/or can be a transformed version of the unstructured service message data 610. In one or more embodiments, the unstructured service message data 610 can correspond to and/or be included in a service message object of the one or more service message objects 302a-N. Additionally, the structured service message data 612 can correspond to a feature dataset for the structured service message data 612.

The information retrieval system 604 can process the structured service message data 612 to facilitate one or more resolutions for a service request related to the unstructured service message data 610. For example, the information retrieval system 604 can extract a passage from the structured service message data 612, search for one or more relevant pages of information from the knowledge base system 606, and/or extract one or more answers for the passage from the machine reading comprehension model 608. In certain embodiments, the information retrieval system 604 can query the knowledge base system 606 based at least in part on respective resolution data objects to determine a resolution message object for the client device 102. The knowledge base system 606 can be an online library of information related to one or more services. In certain embodiments, the information retrieval system 604 can correlate support labels for one or more service message objects to respective resolution data objects based at least in part on the machine reading comprehension model 608 configured for providing resolution predictions related to services messages.

In some embodiments, the information retrieval system 604 can process the structured service message data 612 based on the generative system 609 to facilitate one or more resolutions for a service request related to the unstructured service message data 610. For example, the information retrieval system 604 can process the structured service message data 612 based on one or more generative machine learning models of the generative system 609 to facilitate one or more resolutions for a service request related to the unstructured service message data 610. In some embodiments, the generative system 609 (e.g., the one or more generative machine learning models of the generative system 609) can generate data that represents at least a portion of a resolution action for the structured service message data 612. An example generative system 609 and/or one or more generative machine learning models of the generative system 609 is discussed in detail in connection with the generative interface, generative output service, generative output engine, and/or one or more other generative components disclosed in commonly owned U.S. patent application Ser. No. 18/391,541, titled “GENERATIVE INTERFACE FOR MULTI-PLATFORM CONTENT,” and filed on Dec. 28, 2023, which is hereby incorporated by reference in its entirety.

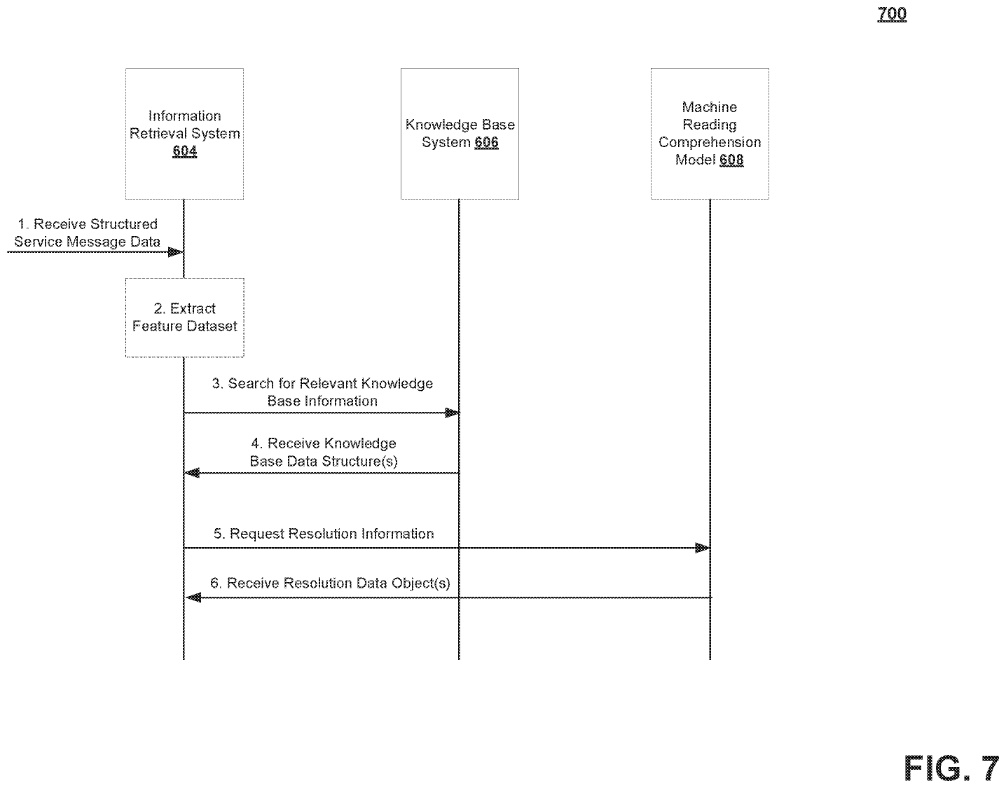

Referring now to FIG. 7, an example communication flow 700 between the information retrieval system 604, the knowledge base system 606, and/or the machine reading comprehension model 608 is presented in accordance with one or more embodiments of the present disclosure. At step 1 of the communication flow 700, the information retrieval system 604 can receive structured service message data such as, for example, the structured service message data 612. In one or more embodiments, the structured service message data can correspond to and/or include a question or query related to a service request. At step 2 of the communication flow 700, the information retrieval system 604 can extract a feature dataset. For example, the information retrieval system 604 can extract a feature dataset from the structured service message data (e.g., the structured service message data 612). In one or more embodiments, the feature dataset can correspond to a passage for the question. At step 3 of the communication flow 700, the information retrieval system 604 can search for relevant knowledge base information. For example, the information retrieval system 604 can transmit a request to the knowledge base system 606 to search for relevant pages related to the passage. At step 4 of the communication flow 700, the information retrieval system 604 can receive one or more knowledge base data structures from the knowledge base system 606. For example, the one or more knowledge base data structures can include relevant knowledge base information related to the passage. In one or more embodiments, the one or more knowledge base data structures can be determined by querying content and/or metadata of the knowledge base system 606 based on one or more knowledge base indexes related to the passage. At step 5 of the communication flow 700, the information retrieval system 604 can request resolution information. For example, the information retrieval system 604 can transmit a request to the machine reading comprehension model 608 for resolution information related to the one or more knowledge base data structures. At step 6 of the communication flow 700, the information retrieval system 604 can receive one or more resolution data objects from the machine reading comprehension model 608. The one or more resolution data objects can be related to one or more resolution actions for the service request associated with the structured service message data.

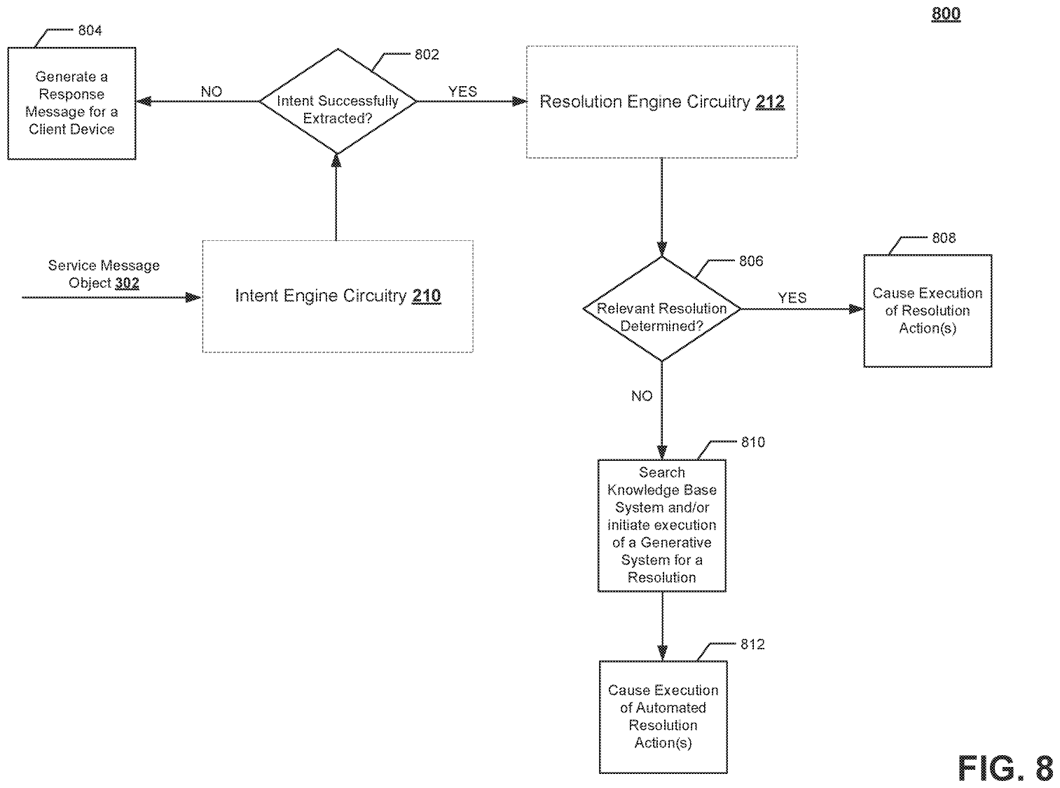

Referring now to FIG. 8, an example flow diagram 800 related to the intent engine circuitry 210 and/or the resolution engine circuitry 212 is presented in accordance with one or more embodiments of the present disclosure. In one or more embodiments, the intent engine circuitry 210 can receive a service message object 302. The service message object 302 can include and/or correspond to a service message query. At step 802 of the flow diagram 800, the intent engine circuitry 210 can determine whether intent is successfully extracted from the service message object 302. For example, the intent engine circuitry 210 can determine whether a feature dataset for the service message object 302 satisfies defined intent criteria for an intent model. If no, the intent engine circuitry 210 can generate a response message for a client device at step 804. For example, the intent engine circuitry 210 can generate a response message object for a client device via a communication channel of the one or more communication channels 304a-N in response to a determination that a feature dataset for the service message object 302 does not satisfy defined intent criteria for an intent model. However, if yes, the service message object 302 and/or data related therewith can be further processed by the resolution engine circuitry 212.

At step 806 of the flow diagram 800, the resolution engine circuitry 212 can determine whether a relevant resolution is determined for the service message object 302. If yes, the resolution engine circuitry 212 can cause execution of one or more resolution actions at step 808. However, if no, the resolution engine circuitry 212 can search a knowledge base system and/or initiate execution of a generative system for a resolution at step 810. Additionally, based on a resolution provided by the knowledge base system, the resolution engine circuitry 212 can cause execution of one or more resolution actions at step 812.

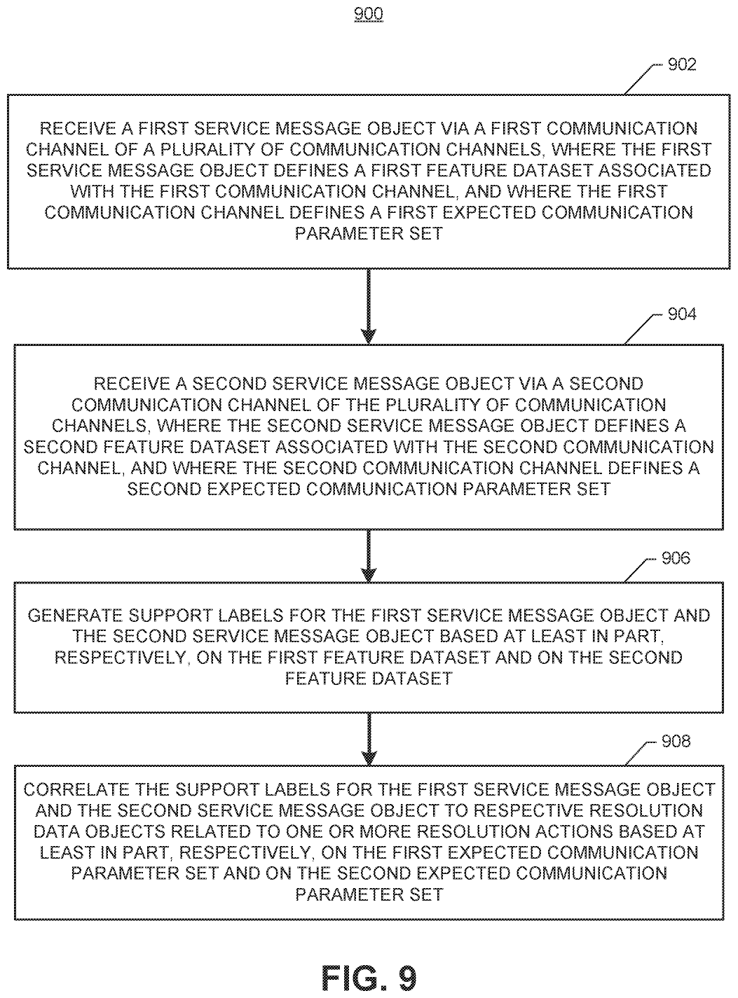

FIG. 9 is a flowchart diagram of an example process 900 for processing multi-channel service data objects to initiate automated resolution action via an intent engine, in accordance with, for example, the intent recognition apparatus 120. Via the various operations of process 900, the intent recognition apparatus 120 can enhance efficiency, reliability and/or effectiveness of the application framework 106 and/or the virtual agent system 110. The process 900 begins at operation 902 that receives a first service message object via a first communication channel of a plurality of communication channels, where the first service message object defines a first feature dataset associated with the first communication channel, and where the first communication channel defines a first expected communication parameter set. In one or more embodiments, the first feature dataset can be generated based at least in part on a feature extraction process that extracts one or more text features, one or more numeric features, binary encoding data, text vectorization data, segmentation data, one or more NLP features, one or more word encodings, TF-IDF data, N-gram data, NER data, the like, or a combination thereof from the first service message object.

The process 900 also includes an operation 904 that receives a second service message object via a second communication channel of the plurality of communication channels, where the second service message object defines a second feature dataset associated with the second communication channel, and where the second communication channel defines a second expected communication parameter set. In one or more embodiments, the second feature dataset can be generated based at least in part on a feature extraction process that extracts one or more text features, one or more numeric features, binary encoding data, text vectorization data, segmentation data, one or more NLP features, one or more word encodings, TF-IDF data, N-gram data, NER data, the like, or a combination thereof from the second service message object. In one or more embodiments, the first feature dataset, the first communication channel, and/or the first expected communication parameter set associated with the first service message object can be different from the second feature dataset, the second communication channel, and/or the second expected communication parameter set associated with the second service message object.

The process 900 also includes an operation 906 that generates support labels for the first service message object and the second service message object based at least in part, respectively, on the first feature dataset and on the second feature dataset. In one or more embodiments, the support labels for the first service message object and/or the second service message object can comprise an intent classification label, a request type label, a message type label, a user identifier label, a location label, a timestamp label, the like, or a combination thereof for the respective services messages. The process 900 also includes an operation 908 that correlates the support labels for the first service message object and the second service message object to respective resolution data objects related to one or more resolution actions based at least in part, respectively, on the first expected communication parameter set and on the second expected communication parameter set. In one or more embodiments, the support labels for the first service message object and the second service message object can be correlated to the respective resolution data objects based at least in part on a machine reading comprehension model configured for providing resolution predictions related to services messages. In one or more embodiments, the respective resolution data objects can be generated based at least in part on a generative machine learning model or a generative system configured for generating data that represents at least a portion of a resolution action for a service message object.

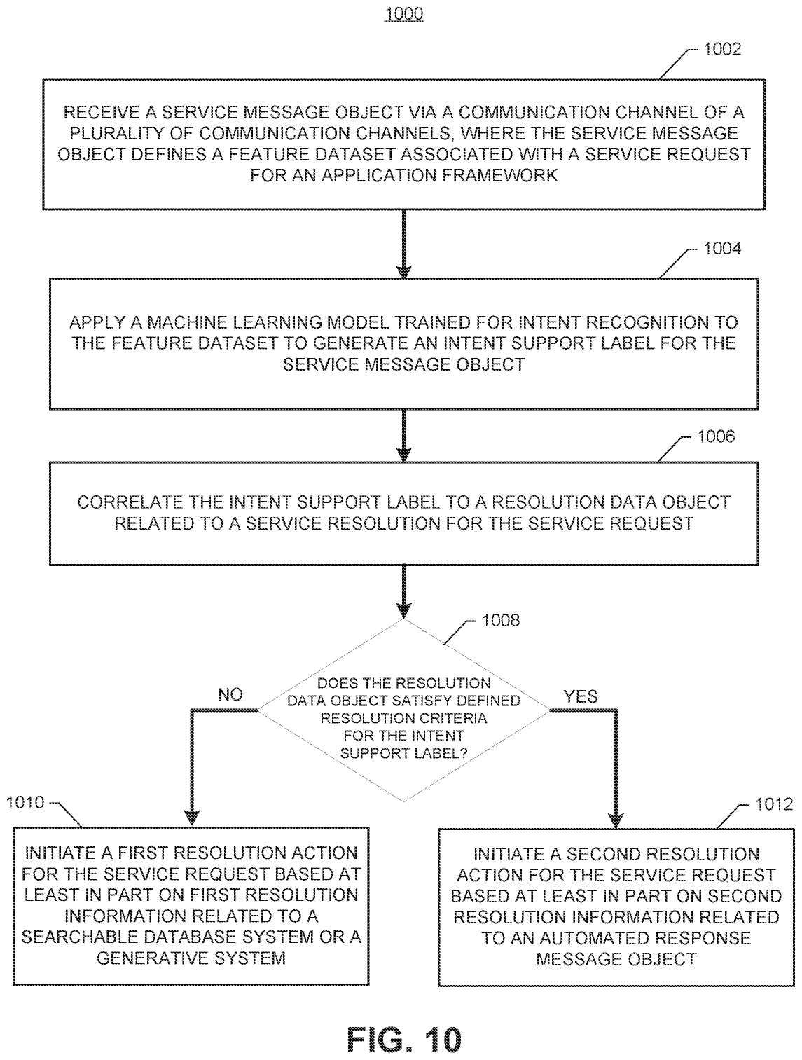

FIG. 10 is a flowchart diagram of an example process 1000 for generating automated resolution actions using intent provided by a trained machine learning model, in accordance with, for example, the intent recognition apparatus 120. Via the various operations of process 1000, the intent recognition apparatus 120 can enhance efficiency, reliability and/or effectiveness of the application framework 106 and/or the virtual agent system 110. The process 1000 begins at operation 1002 that receives a service message object via a communication channel of a plurality of communication channels, where the service message object defines a feature dataset associated with a service request for an application framework. The communication channel can correspond to an email communication channel, a network portal interface communication channel, a user interface widget communication channel, a chat communication channel, an API communication channel, or another type of communication channel.

The process 1000 also includes an operation 1004 that applies a machine learning model trained for intent recognition to the feature dataset to generate an intent support label for the service message object. In certain embodiments, a response message object for a client device via a communication channel of the plurality of communication channels in response to a determination that the feature dataset does not satisfy defined intent criteria for the machine learning model. Additionally, an additional service message object can be received via the communication channel. The additional service message object can define an additional feature dataset associated with the service request. In certain embodiments, the machine learning model trained for intent recognition is applied to the feature dataset and the additional feature dataset to generate the intent support label for the service message object.

The process 1000 also includes an operation 1006 that correlates the intent support label to a resolution data object related to a service resolution for the service request. In certain embodiments, the machine learning model is a first machine learning model and a second machine learning model trained for automated service resolution is applied to the intent support label to generate the resolution data object. In certain embodiments, a set of predefined resolution data objects is queried to select the resolution data object from the set of predefined resolution data objects based at least in part on the intent support label. In certain embodiments, the resolution data object is selected from a ranking of resolution data objects configured based at least in part on the intent support label.

The process 1000 also includes an operation 1008 that determines whether the resolution data object satisfies defined resolution criteria for the intent support label. In certain embodiments, the defined resolution criteria can be related to a determination as to whether a relevant resolution is determined. For example, the defined resolution criteria can be related to a determination as to whether a resolution data object is predetermined for a given intent support label and/or whether a resolution data object is declared and/or correlated to a given intent support label via a virtual agent. In some embodiments, the defined resolution criteria can be related to a determination as to whether a relevant formula (e.g., a help formula index) for a resolution data object is identified in a particular database (e.g., a help formula database for predetermined resolutions). In some embodiments, defined resolution criteria can be related to a certain degree of certainty and/or a certain degree of quality for a resolution data object (e.g., a resolution data object provided by a virtual agent). If no, the process 1000 proceed to operation 1010 that initiates a first resolution action for the service request based at least in part on first resolution information related to a searchable database system or a generative system. However, if yes, the process 1000 proceed to operation 1012 that initiates a second resolution action for the service request based at least in part on second resolution information related to an automated response message object. In certain embodiments, the searchable database system is a knowledge base system and, in response to a determination the resolution data object does not satisfy the defined resolution criteria for the intent support label, the knowledge base system is queried to determine the first resolution information. In certain embodiments, in response to a determination the resolution data object does not satisfy the defined resolution criteria for the intent support label, a generative machine learning model (e.g., a generative machine learning model) is utilized to determine the first resolution information. In certain embodiments, a resolution message object associated with the first resolution information or the second resolution information is transmitted to a client device via the communication channel. In certain embodiments, a resolution ticket data object associated with the first resolution information or the second resolution information is routed to a support device.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web components, web services, web microservices, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising one or more processors and one or more storage devices storing instructions that are operable, when executed by the one or more processors, to cause the one or more processors to:
receive a service message object via a communication channel of a plurality of communication channels, wherein the service message object defines a feature dataset associated with a service request for an application framework;
apply a machine learning model trained for intent recognition to the feature dataset to generate an intent support label for the service message object;
correlate the intent support label to a resolution data object related to a service resolution for the service request; and
based on whether the resolution data object satisfies defined resolution criteria for the intent support label,
initiate a first resolution action for the service request based at least in part on first resolution information related to a searchable database system or a generative system, or
initiate a second resolution action for the service request based at least in part on second resolution information related to an automated response message object.

2. The apparatus of claim 1, wherein machine learning model is a first machine learning model, and wherein the one or more storage devices store instructions that are operable, when executed by the one or more processors, to further cause the one or more processors to:
apply a second machine learning model trained for automated service resolution to the intent support label to generate the resolution data object.

3. The apparatus of claim 1, wherein the one or more storage devices store instructions that are operable, when executed by the one or more processors, to further cause the one or more processors to:
query a set of predefined resolution data objects to select the resolution data object from the set of predefined resolution data objects based at least in part on the intent support label.

4. The apparatus of claim 1, wherein the one or more storage devices store instructions that are operable, when executed by the one or more processors, to further cause the one or more processors to:
select the resolution data object from a ranking of resolution data objects configured based at least in part on the intent support label.

5. The apparatus of claim 1, wherein the one or more storage devices store instructions that are operable, when executed by the one or more processors, to further cause the one or more processors to:
generate a response message object for a client device via a communication channel of the plurality of communication channels in response to a determination that the feature dataset does not satisfy defined intent criteria for the machine learning model;
receive an additional service message object via the communication channel, wherein the additional service message object defines an additional feature dataset associated with the service request; and
apply the machine learning model trained for intent recognition to the feature dataset and the additional feature dataset to generate the intent support label for the service message object.

6. The apparatus of claim 1, wherein the one or more storage devices store instructions that are operable, when executed by the one or more processors, to further cause the one or more processors to:
in response to a determination the resolution data object does not satisfy the defined resolution criteria for the intent support label, utilize a generative machine learning model to determine the first resolution information.

7. The apparatus of claim 1, wherein the one or more storage devices store instructions that are operable, when executed by the one or more processors, to further cause the one or more processors to:
in response to a determination the resolution data object does not satisfy the defined resolution criteria for the intent support label, query a knowledge base system to determine the first resolution information.

8. The apparatus of claim 1, wherein the one or more storage devices store instructions that are operable, when executed by the one or more processors, to further cause the one or more processors to:
transmit a resolution message object associated with the first resolution information or the second resolution information to a client device via the communication channel.

9. The apparatus of claim 1, wherein the one or more storage devices store instructions that are operable, when executed by the one or more processors, to further cause the one or more processors to:
route a resolution ticket data object associated with the first resolution information or the second resolution information to a support device.

10. The apparatus of claim 1, wherein the communication channel corresponds to an email communication channel, a network portal interface communication channel, a user interface widget communication channel, a chat communication channel, or an application programming interface (API) communication channel.

11. A computer-implemented method, comprising:
receiving a service message object via a communication channel of a plurality of communication channels, wherein the service message object defines a feature dataset associated with a service request for an application framework;
applying a machine learning model trained for intent recognition to the feature dataset to generate an intent support label for the service message object;
correlating the intent support label to a resolution data object related to a service resolution for the service request; and
based on whether the resolution data object satisfies defined resolution criteria for the intent support label,
initiating a first resolution action for the service request based at least in part on first resolution information related to a searchable database system or a generative system, or
initiating a second resolution action for the service request based at least in part on second resolution information related to an automated response message object.

12. The computer-implemented method of claim 11, wherein machine learning model is a first machine learning model, and the computer-implemented method further comprising:
applying a second machine learning model trained for automated service resolution to the intent support label to generate the resolution data object.

13. The computer-implemented method of claim 11, further comprising:
querying a set of predefined resolution data objects to select the resolution data object from the set of predefined resolution data objects based at least in part on the intent support label.

14. The computer-implemented method of claim 11, further comprising:
selecting the resolution data object from a ranking of resolution data objects configured based at least in part on the intent support label.

15. The computer-implemented method of claim 11, further comprising:
generating a response message object for a client device via a communication channel of the plurality of communication channels in response to a determination that the feature dataset does not satisfy defined intent criteria for the machine learning model;
receiving an additional service message object via the communication channel, wherein the additional service message object defines an additional feature dataset associated with the service request; and
applying the machine learning model trained for intent recognition to the feature dataset and the additional feature dataset to generate the intent support label for the service message object.

16. The computer-implemented method of claim 11, further comprising:
in response to a determination the resolution data object does not satisfy the defined resolution criteria for the intent support label, utilizing a generative machine learning model to determine the first resolution information.

17. The computer-implemented method of claim 11, further comprising:
in response to a determination the resolution data object does not satisfy the defined resolution criteria for the intent support label, querying a knowledge base system to determine the first resolution information.

18. The computer-implemented method of claim 11, further comprising:
transmitting a resolution message object associated with the first resolution information or the second resolution information to a client device via the communication channel.

19. The computer-implemented method of claim 11, further comprising:
routing a resolution ticket data object associated with the first resolution information or the second resolution information to a support device.

20. A computer program product, stored on a computer readable medium, comprising instructions that when executed by one or more computers cause the one or more computers to:
receive a service message object via a communication channel of a plurality of communication channels, wherein the service message object defines a feature dataset associated with a service request for an application framework;
apply a machine learning model trained for intent recognition to the feature dataset to generate an intent support label for the service message object;
correlate the intent support label to a resolution data object related to a service resolution for the service request; and
based on whether the resolution data object satisfies defined resolution criteria for the intent support label,
initiate a first resolution action for the service request based at least in part on first resolution information related to a searchable database system or a generative system, or
initiate a second resolution action for the service request based at least in part on second resolution information related to an automated response message object.
